(19) United States
(12) Patent Application Publication
(10) Pub. No.: US 2011/0170189 A1
(43) Pub. Date: Jul. 14, 2011

(54) METHOD AND APPARATUS FOR PRIVACY ENHANCEMENT

(76) Inventor: Dennis J. Jackson, II, Arlington, TX (US)

(21) Appl. No.: 13/060,189

(22) PCT Filed: Aug. 22, 2008
(86) PCT No.: PCT/US2009/054449

§ 371 Date: Feb. 22, 2011

Related U.S. Application Data
(60) Provisional application No. 61/091,138, filed on Aug. 22, 2008.

(51) Int. Cl. G02B 27/28

(52) U.S. Cl. 359/492.01

(57) ABSTRACT

A privacy-enhancement system includes a window that includes a first polarized filter and a media display that includes a second polarized filter. A polarization axis of the first polarized filter and a polarization axis of the second polarized filter are not parallel to one another.

### CROSS-REFERENCE TO RELATED APPLICATIONS

This patent application claims priority from, and incorporates by reference for any purpose the entire disclosure of, U.S. Provisional Patent Application No. 61/091,138, filed on Aug. 22, 2008.

### BACKGROUND

1. Technical Field

This patent application relates generally to enhancing privacy and, more particularly, but not by way of limitation, to a method of and apparatus for utilizing polarized filters to shield vehicle occupants and any media they may be viewing from being seen by viewers outside a vehicle.

2. History of Related Art

Polarized filtering of unpolarized electromagnetic light waves has long been known as a way of altering light waves that reach a viewer. A well-known example is polarized sunglasses used to reduce a perception of glare of the sun off non-metallic surfaces. Use of Liquid Crystal Display (LCD) polarized layers for modulating visibility of color pixels on a display is another common polarization application.

Applying films or inherent tinting to windows to filter wavelengths or quantity of light passing through a window is also a well-known application. For automobiles, however, to ensure sufficient light transmission through windows for safe viewing by a driver or to allow police to see into a vehicle, a magnitude of permissible window tinting is regulated by law. The U.S. Department of Transportation sets limits for commercial vehicles, and each state has laws regulating visible-light transmission requirements for the windows of privately owned vehicles. Regulations limiting tinting on vehicle windows may prevent a vehicle owner from blocking those outside the vehicle from seeing inside the vehicle and, as an example, viewing media being displayed to occupants in the vehicle.

### SUMMARY OF THE INVENTION

A privacy-enhancement system includes a window that includes a first polarized filter and a media display that includes a second polarized filter. A polarization axis of the first polarized filter and a polarization axis of the second polarized filter are not parallel to one another.

A system for enhancing privacy of a vehicle includes a first window that includes a first polarized filter and a second window that includes a second polarized filter. A polarization axis of the first polarized filter and a polarization axis of the second polarized filter are not parallel to one another.

A method for enhancing privacy of a vehicle includes applying a first polarized filter to a first window of the vehicle and applying a second polarized filter to a screen of a media display located within the vehicle. A polarization axis of the first polarized filter and a polarization axis of the second polarized filter are not parallel to one another.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1A is a diagram illustrating a system;

FIG. 1B is a diagram illustrating a system incorporating polarized filters on portions of a vehicle for privacy enhancement;

FIG. 2A is a diagram illustrating a system;

FIG. 2B is a diagram illustrating a system incorporating polarized filters on side windows of a vehicle for privacy enhancement;

FIG. 3A is a diagram illustrating a system;

FIG. 3B is a diagram illustrating a system incorporating polarized filters on portions of a vehicle for privacy enhancement; and

FIG. 4 is a flow diagram of a process for incorporating polarized filters on portions of a vehicle for privacy enhancement.

### DETAILED DESCRIPTION OF ILLUSTRATIVE EMBODIMENTS OF THE INVENTION

Various embodiments of the present invention will now be described more fully with reference to the accompanying drawings. The invention may, however, be embodied in many different forms and should not be construed as limited to the embodiments set forth herein; rather, the embodiments are provided so that this disclosure will be thorough and complete, and will fully convey the scope of the invention to those skilled in the art.

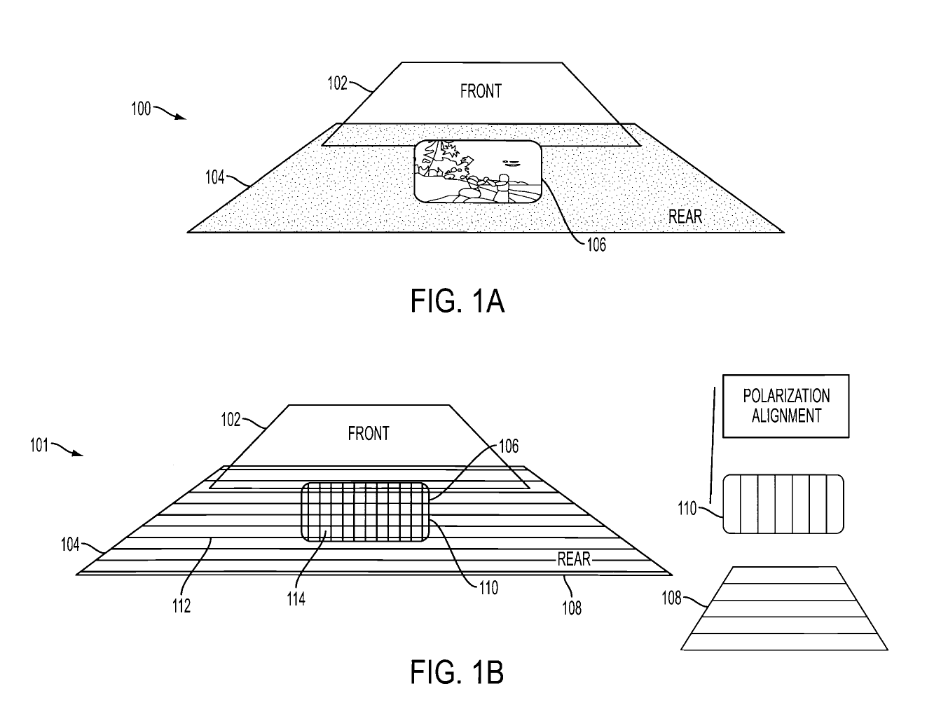

FIG. 1A is a diagram illustrating a system 100. FIG. 1A is from a perspective of a viewer behind the vehicle that is moving directly away from the viewer. The system 100 includes a windshield 102 and a rear window 104 of the vehicle. The system 100 further includes a media display 106. In a typical embodiment, the media display 106 may be, for example, a screen mounted inside the vehicle for viewing video or other media by vehicle occupants. The arrangement as illustrated in FIG. 1A allows a viewer outside the vehicle, under at least some conditions, to see a screen of the media display 106 through the rear window 104. In other embodiments, the screen of the media display 106 could in at least some situations be viewable through a front windshield, a side window, a sunroof, or other window.

FIG. 1B is a diagram illustrating an exemplary system 101 incorporating orthogonally oriented polarized filters on portions of a vehicle for privacy enhancement. In a typical embodiment, the rear window 104 may be altered by, for example, a polarized filter 108 to form a polarized rear window 112. In a typical embodiment, the media display 106 may also be altered by, for example, a polarized filter 110 to form a polarized media display 114. In a typical embodiment, an orientation of an axis of the polarized filter 108 on the rear window 104 and of the polarized filter 110 on the media display 106 are orthogonal. The orthogonal orientation of the polarized filters 108, 110 relative one another prevents light emanating from the polarized media display 114 from passing through the orthogonally-polarized rear window 112, thus making the polarized media display 114 non-visible through the orthogonally-polarized rear window 112. As a result, a viewer from outside the orthogonally-polarized rear window 112 is unable to view the polarized media display 114. Those having skill in the art will appreciate that the orientation of the polarized filters 108, 110 can be varied as design considerations dictate without departing from principles of the invention. For example, the orientation of the polarized filters 108, 110 can be varied at 1° increments.

In a typical embodiment, the polarized filters 108, 110 may be, for example, integrally manufactured into at least one of, for example, the rear window 104 or the media display 106. In other embodiments, the polarized filters 108, 110 may be applied, for example, as an overlay onto the rear window 104 and the media display 106. The overlay may be, for example, removable or applied permanently. In other embodiments, the polarized filter 110 may be a separate piece placed or attached in front of the media display 106. Polarized filters utilized with windows or media displays in accordance with principles of the invention may also be integral to the item of which the polarized filters are a part.

In a typical embodiment, the polarized media display 114 may face the rear window 104 of the vehicle. In other embodiments, the polarized media display 114 may face a window in any space that the polarized media display 114 might occupy. The polarized media display 114 is not limited to a display of media, but may be a presentation of any desired information.

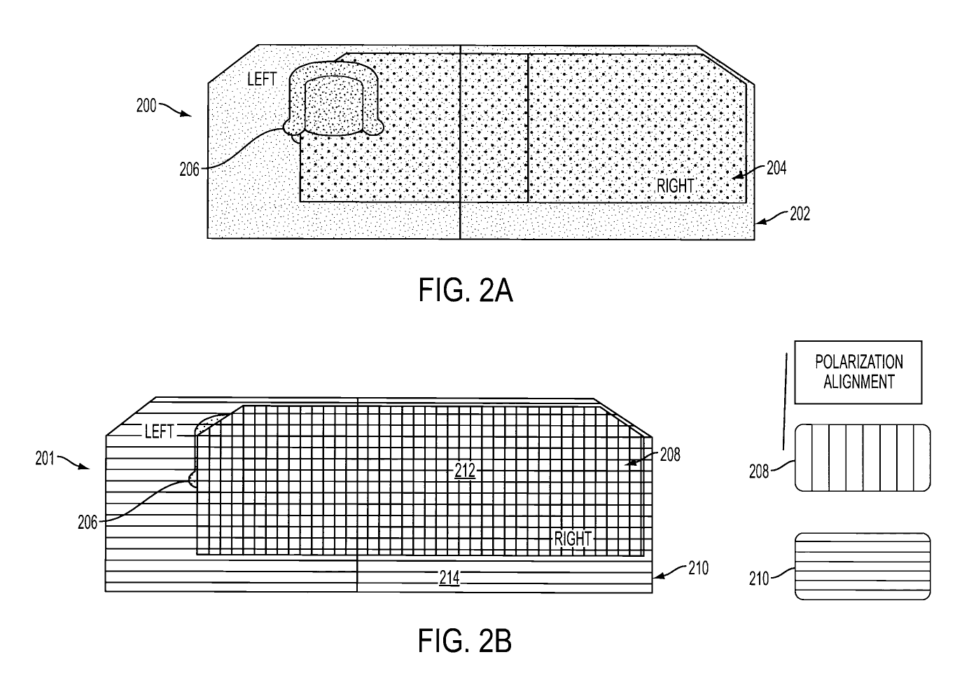

FIG. 2A is a diagram illustrating a system 200. The system 200 includes left side windows 202 and right side windows 204 of the vehicle as viewed from outside the vehicle as the vehicle is pointed toward a viewer's left. In the embodiment illustrated in FIG. 2A, the vehicle's body, windshield, and rear window are not shown. Also shown in FIG. 2A is a silhouette 206 of an occupant inside the vehicle. The silhouette 206 is visible in FIG. 2A because, for example, when an interior of the vehicle is not illuminated, such as when driving at night, light entering the vehicle through the right side windows 204 exits through the left side windows 202, thus silhouetting occupants of the vehicle to a viewer looking into the vehicle through the left side windows 202.

FIG. 2B is a diagram illustrating a system 201 incorporating polarized filters on side windows of a vehicle for privacy enhancement. In a typical embodiment, the left-side windows 202 may be altered by, for example, a polarized filter 210 to form polarized left-side windows 214. In a typical embodiment, the right-side windows 204 may also be altered by, for example, a polarized filter 208 to form polarized right-side windows 212. In a typical embodiment, an orientation of an axis of the polarized filter 210 on the left side windows 202 and of the polarized filter 208 on the right side windows 204 is orthogonal.

As a result, light passing through the polarized right-side windows 212 cannot pass through the orthogonally-polarized left-side windows 214. For example, if the interior of the vehicle is not illuminated, such as at night, a viewer looking into the orthogonally-polarized left-side windows 214 does not see any backlight coming through the polarized right-side windows 212, and thus does not see the silhouette 206 of any vehicle occupant. Because occupants inside the vehicle look out through only a single window, their view out of the vehicle is filtered only in a single axis; thus, the light reaching them will not be reduced by a nominal light transmission characteristics of a tint (e.g., 20%-50% light passivity range). In addition, for example, the silhouette 206 may be broken up in other backlit scenarios or where the exterior of the vehicle opposite a viewer is lighter than the vehicle interior. By eliminating or reducing the visibility, for example, of a vehicle occupant, even when the vehicle is lit inside, privacy would nonetheless be improved.

In a typical embodiment, the polarized filters 208, 210 may be, for example, integrally manufactured into at least one of, for example, the left-side windows 202 and the right-side windows 204. In other embodiments, the polarized filters 208, 210 may be applied as, for example, an overlay onto the right-side windows 204 and the left-side windows 202. The overlay may be, for example, removable or applied permanently.

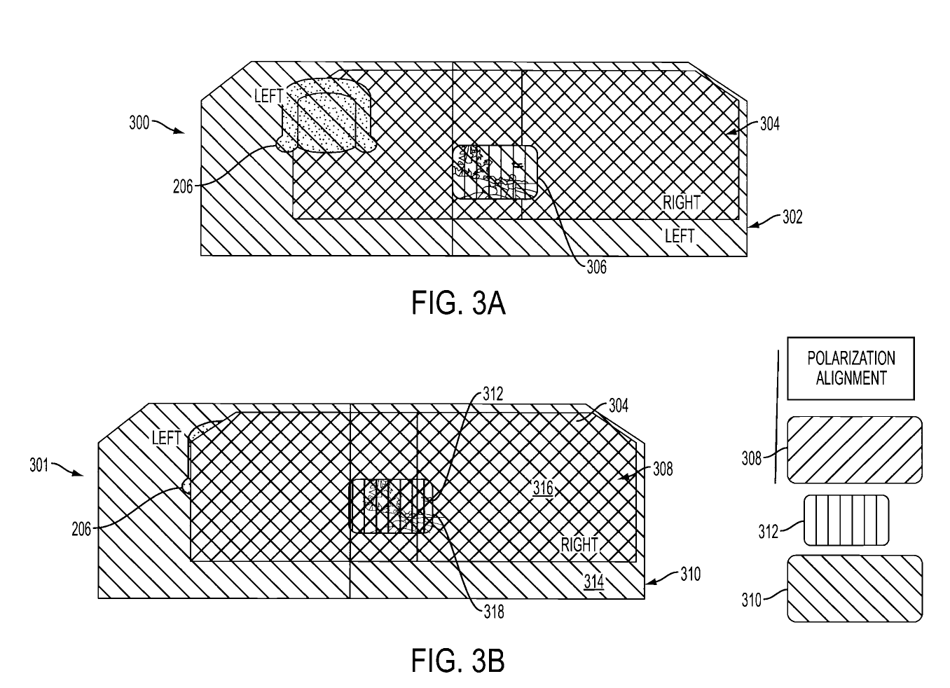

FIG. 3A is a diagram illustrating a system 300. The system 300 includes left-side window 302 and right-side windows 304 of the vehicle as viewed from outside the vehicle as the vehicle is pointed towards a viewer's left. In the embodiment illustrated in FIG. 3A, the vehicle's body, windshield, and rear window are not shown. Also shown in FIG. 3A is a silhouette 206 of an occupant inside the vehicle. The silhouette 206 is visible in FIG. 3A because, for example, when an interior of the vehicle is not illuminated, such as at night, light entering the vehicle through the right-side windows 304 exits through the left-side windows 302, thus silhouetting occupants of the vehicle to a viewer looking into the vehicle through the left-side windows 302. Also shown in FIG. 3A is a media display 306 inside the vehicle.

FIG. 3B is a diagram illustrating a system 301 incorporating polarized filters on the left-side windows 302, the right-side windows 304, and the media display 306 for privacy enhancement. In a typical embodiment, the left-side windows 302 may be altered by, for example, a polarized filter 310 to form polarized left-side windows 314. In a typical embodiment, the right-side windows 304 may also be altered by, for example, a polarized filter 308 to form polarized right-side windows 316. In a typical embodiment, the media display 306 may also be altered by, for example, a polarized filter 312 to form a polarized media display 318.

More particularly, FIG. 3B shows that, when the axes of the polarized right-side windows 316 and the polarized left-side windows 314 are oriented orthogonally to each other, but are also oriented at a 45° angle to an axis of the polarized media display 318, the polarized media display 318 is 75% darkened to a viewer looking into the vehicle through either of the polarized left-side windows 314 or the polarized right-side windows 316. In some embodiments, the visibility of the polarized media display 318 to a viewer outside the vehicle can be altered from zero to one-hundred percent by altering the orientations of the axes of the polarized media display 318, the polarized left-side windows 314, and polarized right-side windows 316.

In a typical embodiment, the polarized filters 308, 310, 312 may be, for example, integrally manufactured into at least one of, for example, the left-side and right-side windows 302, 304 or the media display 306. In other embodiments, the polarized filters 308, 310, 312 may be applied as, for example, an overlay onto the left-side and right-side windows 302, 304 or the media display 306. The overlay may, for example, be removable or applied permanently. In other embodiments, the polarized filters 312 may be a separate piece placed or attached in front of the media display 306.

In some embodiments, the media display 306, the left-side windows 302, and the right-side windows 304 could be part of any space an occupant or media display might occupy. In some embodiments, any number of windows may have polarization orientations at varying degrees to block viewing of particular objects by observers looking through some particular number of windows. In addition, those having skill in the art will appreciate that principles of the invention may be applied to either tinted or untinted materials (e.g., windows). Moreover, although in a typical embodiment, transmission of light is described as being blocked 100%, however, any percentage from 0-100% could be chosen, for example, at 1% increments, as design criteria dictate. For example, one might not want to make the vehicle so that a viewer cannot see through it, but instead reduce light transmission by only 67%. Similar design criteria could be applied to a media display, in which light transmitted out the back of the vehicle is 100% blocked, while the light transmitted out of side windows of the vehicle is reduced by 52%.

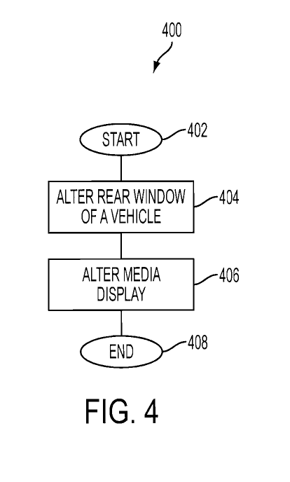

FIG. 4 is a flow diagram of a process for incorporating polarized filters on portions of a vehicle for privacy enhancement. For illustrative purposes, a process 400 will be described in conjunction with FIGS. 1A-1B. The process 400 starts at step 402. At step 404, a rear window 104 of the vehicle is altered. In a typical embodiment, the rear window 104 may be altered by, for example, a polarized filter 108 to form a polarized rear window 112. At step 406, a media display 106 within the vehicle is altered. In a typical embodiment, the media display 106 is altered by, for example, a polarized filter 110 to form a polarized media display 114. In a typical embodiment, an orientation of an axis of the polarized filter 108 on the rear window 104 and of the polarized filter 110 on the media display 106 are orthogonal relative to one another. The orthogonal orientation of the polarized filters 108, 110 prevents light emanating from the orthogonally-polarized media display 114 from passing through the orthogonally-polarized rear window 112, thus making the orthogonally-polarized media display 114 non-visible through the orthogonally-polarized rear window 112. As a result, a viewer from outside the orthogonally-polarized rear window 112 is unable to view the orthogonally-polarized media display 114. Those having skill in the art will appreciate that the orientation of the polarized filters 108, 110 can be varied as design considerations dictate without departing from principles of the invention. At step 408, the process 400 ends.

Although various embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit and scope of the invention as defined by the appended claims. For example, the windows or media displays to which polarization as set forth herein may be applied need not necessarily be associated with a vehicle. In addition, polarization as described herein can be applied to any window or display as needed, including front windshields and sunroofs of vehicles. Moreover, even though various windows and media-display screens may be planar, this not need be the case in order for principles of the invention to be utilized, as such principles could be utilized even if curved surfaces are involved.

What is claimed is:

1. A privacy-enhancement system comprising:
a window comprising a first polarized filter;
a media display comprising a second polarized filter;
wherein a polarization axis of the first polarized filter and a polarization axis of the second polarized filter are not parallel to one another; and
wherein visibility of the media display through the window is at least partially obscured.

2. The system according to claim 1, wherein the polarization axis of the first polarized filter and the polarization axis of the second polarized filter are orthogonal.

3. The system according to claim 1, wherein an orientation of the polarization axes relative to one another is selected from the group consisting of 1°-89° at 1° intervals.

4. The system according to claim 1, wherein the first and second polarized filters are applied as overlays.

5. The system according to claim 1, wherein the first and second polarized filters are removable.

6. The system according to claim 1, wherein the first and second polarized filters are applied permanently.

7. The system according to claim 1, wherein the second polarized filter is a separate piece placed in front of the media display.

8. The system of claim 1, wherein the first polarization filter is integral to the window.

9. The system of claim 1, wherein the second polarization filter is integral to the media display.

10. The system of claim 1, wherein a plane of the second polarized filter is not perpendicular to a plane of the first polarized filter.

11. A system for enhancing privacy of a vehicle, the system comprising:
a first window exposed to an exterior environment, the first window comprising a first polarized filter;
a second window exposed to the exterior environment, the second window comprising a second polarized filter;
wherein a space is defined by the first window and the second window;
wherein a polarization axis of the first polarized filter and a polarization axis of the second polarized filter are not parallel to one another;
wherein the first polarized filter and the second polarized filter, in combination, reduce backlighting of an object, by a light source located in the exterior environment, located within the space; and
wherein visibility of by occupant located within the space out the first window and the second window is not diminished by the first polarized filter or the second polarized filter.

12. The system of claim 11, further comprising a media display within the vehicle, the media display comprising a third polarized filter.

13. The system of claim 12, wherein the polarization axis of the first polarized filter and the polarization axis of the second polarized filter are each non-parallel to a polarization axis of the third polarization filter.

14. The system of claim 13, wherein an orientation of the polarization axis of the first polarization filter and an orientation of the polarization axis of the second polarization filter are each independently selected from the group consisting of 0°-45° at 1° intervals.

15. The system of claim 11, wherein the first, second, and third polarized filters are applied as overlays.

16. The system of claim 11, wherein the first, second, and third polarized filters are removable.

17. The system of claim 11, wherein the first, second, and third polarized filters are applied permanently.

18. The system of claim 11, wherein the third polarized filter is a separate piece placed in front of the media display.

19. The system of claim 11, wherein the first polarization filter is integral to the first window.

20. The system of claim 11, wherein the second polarization filter is integral to the second window.

21. The system of claim 11, wherein the third polarization filter is integral to the media display.

22. The system of claim 11, wherein a plane of the second polarized filter is not perpendicular to a plane of the first polarized filter.

23. A method for enhancing privacy of a vehicle, the method comprising:
applying a first polarized filter to a first window of the vehicle;
applying a second polarized filter to a screen of a media display located within the vehicle;
wherein a polarization axis of the first polarized filter and a polarization axis of the second polarized filter are not parallel to one another.

24. The method of claim 23, wherein a plane of the second polarized filter is not perpendicular to a plane of the first polarized filter.

25. A privacy enhancement system comprising:
a window comprising a first polarizing filter;
a media display comprising a second polarizing filter;
a space defined between the window and the media display;
wherein the media display is visible to an occupant in the space; and
wherein visibility of the media display through the window is at least partially obscurred.
